(19) United States
(12) Patent Application Publication
(10) Pub. No.: US 2021/0020875 A1
(43) Pub. Date: Jan. 21, 2021

(54) DEVICE AND METHOD FOR DISTRIBUTING A CAVITY-FILLING COMPOUND IN A BATTERY

(71) Applicant: AUDI AG, Ingolstadt (DE)

(72) Inventors: Martin RIEBLINGER, Schrobenhausen (DE); Martin SCHUESSLER, Koesching (DE)

(73) Assignee: AUDI AG, Ingolstadt (DE)

(21) Appl. No.: 16/927,274

(22) Filed: Jul. 13, 2020

(30) Foreign Application Priority Data
Jul. 15, 2019 (DE) 102019210437.1

(51) Int. Cl. H01M 2/08; H01M 10/653

(52) U.S. Cl. CPC H01M 2/08; H01M 10/653

(57) ABSTRACT

A distribution device for distributing a cavity-filling compound in a cavity between at least one outer side of at least one battery module of a battery and an inner side, facing the at least one outer side of the respective battery module of the battery, of a battery housing at least partially enclosing the respective battery module. At least one injection nozzle and a vacuum-generation device, wherein the at least one injection nozzle is designed to inject the cavity-filling compound into the cavity, and wherein the vacuum-generation device is designed to generate a vacuum in an interior of the sealed battery housing, said interior including the cavity, and to draw the injected cavity-filling compound into the cavity and to distribute it by the vacuum.

### FIELD

The disclosure relates to a distribution device for distributing a cavity-filling compound in a cavity between at least one outer side of at least one battery module of a battery and an inner side, facing the at least one outer side of the respective battery module, of a battery housing of the battery, the battery housing at least partially enclosing the respective battery module. The disclosure further relates to a method for distributing a cavity-filling compound in such a cavity.

### BACKGROUND

During assembly of a battery, when at least one battery module is installed in a battery housing at least partially enclosing the battery module, a cavity can develop, for example caused by the installation, between at least one outer side of the at least one battery module and an inner side of the battery housing, said inner side facing the at least one outer side of the battery module. Because the development of such a cavity can have a negative effect during operation of the battery, there are various measures for filling or filling in the cavity. In this case, at least one thermally conductive material or a thermally conductive paste can be used as the cavity-filling compound in order to establish, at the same time the undesirable cavity is being filled, thermal contacting between the at least one battery module and a temperature control device arranged normally on or in the battery housing.

The thermally conductive paste is normally first supplied to the battery housing. Battery modules to be assembled are then inserted into the battery housing and pressed onto the thermally conductive paste. In order to displace excessive thermally conductive paste, generally a high press-on pressure is generated in this case, which can have negative effects on the associated components.

DE 10 2014 226 249 A1 describes, for example, a battery system with battery cells and a tempering plate. A thermally conductive means is arranged between the battery cells and the tempering plate, said thermally conductive means filling a cavity between the tempering plate and the battery cells.

Moreover, DE 10 2018 005 234 A1 discloses a method for applying a thermally conductive paste to battery cells of a battery. To this end, it is determined, in a laborious method, which height a respective battery cell has in order to then adapt the metered quantity of thermally conductive paste to the height of the respective battery cell.

Such filling or thermally conductive elements are also known from the prior art which are not present in the form of a compound or paste or cream. In the case of DE 10 2015 002 828 A1, the cooling elements are cooling elements coated with a plastic arranged between and under individual battery cells. DE 10 2017 213 887 A1 describes a thermally conductive element designed as a structure consisting of several fibers comprising at least one metal. The disadvantage in this case is that the cooling elements or thermally conductive elements have no flexibility or only to a limited extent with respect to their capacity to be deformed or adapted to the respective cavity.

### SUMMARY

The object upon which the invention is based is to provide a device and a method for the efficient and material-protecting application of a cavity-filling compound into a cavity of the previously described assembly and for the distribution of the cavity-filling compound into the cavity.

The invention provides a distribution device for distributing a cavity-filling compound in the previously described cavity between at least one outer side of at least one battery module of a battery and an inner side, facing the at least one outer side of the respective battery module of the battery, of a battery housing of the battery, the battery housing at least partially enclosing the respective battery module.

The distribution device according to the invention has at least one injection nozzle. To this end, the at least one injection nozzle is designed to inject the cavity-filling compound into the cavity. To do this, the at least one injection nozzle can be connected to the battery housing, for example, at a predetermined injection site, e.g. an injection site in the form of an inlet opening. The connection can be implemented by means of a screw connection or a plug connection or a vacuum connection. It may be expedient to connect a plurality of injection nozzles to the battery housing for injecting the cavity-filling compound at various injection sites.

Moreover, the distribution device according to the invention has a vacuum-generation device which may be implemented, for example, by means of a pump. According to the invention, the vacuum-generation device is designed to generate a vacuum in an interior of the sealed battery housing, said interior comprising or containing the cavity. To this end, the vacuum-generation device is expediently designed to be connected to the sealed battery housing. The connection can be implemented, for example, at a connection opening of the battery housing designed for this purpose. A vacuum in terms of the invention is an air pressure or gas pressure which is less than the surrounding atmospheric pressure. In particular, the vacuum is less than 0.9 bar. To ensure that a vacuum can be generated in the sealed battery housing by means of the vacuum-generation device, the battery housing, in the sealed state, is preferably closed off in a gas-tight manner. In addition, the vacuum-generation device is designed to draw the injected cavity-filling compound into the cavity and to distribute it there by means of the vacuum. Thus, the generated vacuum enables, in an advantageous manner, the cavity-filling compound to be drawn into the cavity and distributed in the cavity.

The following method can be implemented by means of the distribution device according to the invention.

The method according to the invention provides that at least one injection nozzle of the distribution device injects the cavity-filling compound into the cavity. To this end, it may be provided, for example, that the at least one injection nozzle is arranged at a predetermined injection site of the sealed battery housing. As previously described herein, the injection can be implemented at various injection sites by means of a single or also by means of a plurality of injection nozzles.

The method according to the invention further provides that a vacuum-generation device, particularly a pump, establishes or generates a vacuum in an interior of the sealed battery housing, said interior comprising the cavity. As previously described herein, the vacuum-generation device can be connected to the sealed battery housing to do this. The connection can be implemented, for example, as a hose connection or tube connection. To this end, it may be provided, for example, that the battery housing has corresponding connection points or connections.

The method according to the invention further provides that the injected cavity-filling compound is drawn into the cavity and distributed there by means of the thusly generated vacuum.

The invention provides the advantage that a counter-pressure in the interior of the sealed battery housing, said counter-pressure counteracting the injection of the cavity-filling compound, is reduced due to generation of the vacuum. This reduced counter-pressure enables efficient injection of the cavity-filling compound. The processing time necessary for this can be advantageously shortened. The mechanical load of the battery housing and/or of the at least one battery module can also be reduced in the interior of the battery housing, because an injection pressure can be reduced during injection of the cavity-filling compound as a result of the reduced counter-pressure.

The invention also includes embodiments which result in additional advantages.

Thus, one embodiment provides that the vacuum-generation device has a cover or a sealing cup for sealing the battery housing. In other words, the vacuum-generation device has a suction cup or vacuum cup, which can be placed on the battery housing and can seal it in a gas-tight manner. This results in the advantage that the sealing cup can then be removed after injection of the cavity-filling compound is complete in order to control, for example, the distribution of the cavity-filling compound in the cavity. However, a cover of the battery itself can also be used as the cover.

A further embodiment provides that the vacuum-generation device is configured to suction the at least one injection nozzle to the battery housing, by means of the vacuum, at at least one predetermined injection site. This results in the advantage that no further fixing option must be provided, particularly in the form of a screw connection or a plug connection, in order to retain the injection nozzle on the battery housing. This is provided by the vacuum in the embodiment described herein.

According to a further advantageous embodiment, the injection nozzle has a pressure-retention device which is configured to establish and maintain a counter-pressure counteracting an expansion pressure of the cavity-filling compound. Such a pressure-retention device may be implemented, for example, by means of a pressure-retention valve. This provides the advantage that a backflow of at least a part of the injected cavity-filling compound out of the cavity can be prevented by means of the pressure-retention valve.

According to a further embodiment, a vibration-generation device for generating a vibration in the injection nozzle and/or in the cavity-filling compound is provided on the injection nozzle. Such a vibration-generation device may be designed, for example, as a mechanically and/or hydraulically drivable piston or punch, which transfers a pressure pulse to the cavity-filling compound and/or to the injection nozzle at a predetermined frequency. The cavity-filling compound is hereby advantageously better distributed in the cavity.

A further advantageous embodiment provides that a mechanical vibrator is configured to transfer a vibratory movement, which is acting in at least one spatial direction, to the battery housing during injection. In other words, it may be provided that the battery housing is arranged on a mechanical vibrating table during injection and is vibrated by the vibratory movement of the vibrating table. Due to the vibratory movement acting in at least one spatial direction, the cavity-filling compound is further distributed in an advantageous manner during injection.

According to an advantageous refinement, the cavity-filling compound is designed as a thixotropic fluid. Thixotropy characterizes the property of a fluid to lose viscosity under the effect of a shear force. In other words, a thixotropic fluid becomes less viscous under the effect of a shear force as compared to a starting viscosity state. If the effective force ceases, the fluid returns to the starting viscosity state. In association with the present invention, use of a thixotropic fluid as the cavity-filling compound has the advantage that the cavity-filling compound is liquefied due to the previously described vibration and/or vibratory movement and is thus more efficient to inject. A customary cavity-filling compound can be rendered thixotropic, for example, by adding silica gel. Because a thixotropic fluid solidifies in the absence of the mechanical load or deformation, i.e. particularly in the absence of the previously described vibration and/or vibratory movement, a next work step can be added, directly following the injecting of the cavity-filling compound.

As previously described, the invention also relates to a method for distributing a cavity-filling compound.

The invention also includes refinements of the method according to the invention, which have features as they have already been described in association with the refinements of the distribution device according to the invention. For this reason, the corresponding refinements of the method according to the invention are not described again here.

According to an advantageous refinement of the previously described method according to the invention, the at least one battery module and the battery housing are moved relative to one another during injection of the cavity-filling compound. This can be implemented likewise, for example, through the use of a vibrating table. This results in the advantage that the cavity-filling compound is further distributed in the interior of the battery housing.

A further advantageous refinement of the method according to the invention provides that a distance is enlarged between the at least one battery module and the battery housing in order to produce a suction effect during injection of the cavity-filling compound, and the cavity-filling compound is drawn into the cavity by the suction effect and distributed there. The enlargement of the aforementioned distance results in an enlarged flow cross-section, within which the cavity-filling compound can flow or be distributed. Accordingly, the distance can again be reduced back to its original value.

The invention also comprises the combinations of the features of the described embodiments.

### BRIEF DESCRIPTION OF THE DRAWINGS

Exemplary embodiments of the invention are described in the following. The following is shown:

FIG. 1 a schematic representation of a distribution device for distributing a cavity-filling compound;

FIG. 2 a schematic detailed side view of an injection nozzle; and

FIG. 3 a schematic representation of an embodiment of the method according to the invention for distributing a cavity-filling compound.

### DETAILED DESCRIPTION

The exemplary embodiments explained in the following refer to preferred embodiments of the invention. With the exemplary embodiments, the described components of the embodiments represent individual features to be considered independently of one another, which also further embody the invention independently of one another. Thus, the disclosure should also comprise combinations of the features of the embodiments other than those shown. Furthermore, the described embodiments can also be supplemented through further described features of the invention.

The same reference numerals refer to equivalent features and functions in the figures.

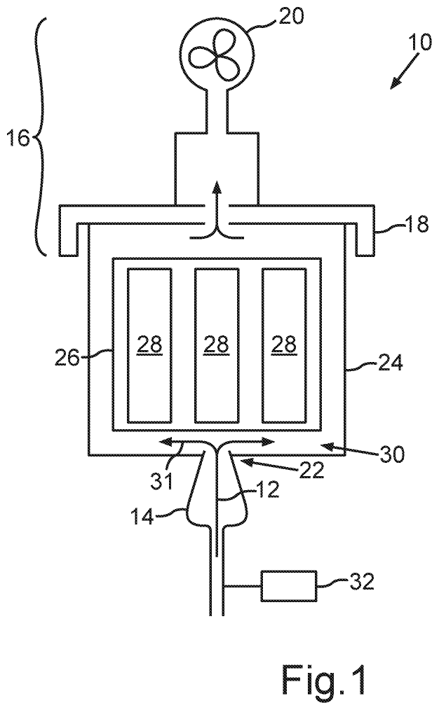

FIG. 1 shows a distribution device 10 for distributing a cavity-filling compound 12. In the embodiment shown here, the distribution device 10 has an injection nozzle 14 and a vacuum-generation device 16. In addition, the vacuum-generation device 16 shown here has a cover 18 and a pump 20 arranged on the cover.

In the exemplary embodiment shown in FIG. 1, the injection nozzle 14 is connected to a battery housing 24 at a predetermined injection site 22. A battery module 26, comprising several battery cells 28, is arranged in the interior of the battery housing 24. A cavity 30 is shown in FIG. 1 between the battery housing 24 and the battery module 26. The arrows 31 in FIG. 1 indicate how the cavity-filling compound 12 is drawn into the cavity 30 between the battery housing 24 and the battery module 26 and distributed there due to the vacuum generated by the vacuum-generation device 16. In the exemplary embodiment shown in FIG. 1, backflow of the cavity-filling compound 12 can be prevented by a retaining device 32, which can be designed, for example, as a pressure-retention valve.

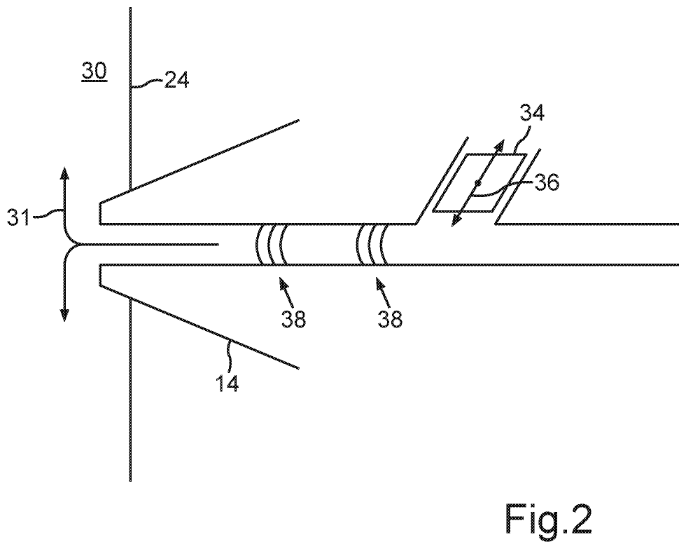

FIG. 2 shows a schematic, lateral, longitudinal section of an injection nozzle 14 with reference to the components described in connection with FIG. 1. In the embodiment shown here, the injection nozzle 14 has a vibration-generation device 34. The vibration-generation device 34 can be implemented by means of a piston moveably mounted in the direction of the arrow 36. The up and down movements of the piston in the direction of the arrow 36 generate a vibration 38, for example in the form of pressure waves or pressure pulses, in the injection nozzle 14 and/or in the cavity-filling compound 12. If the cavity-filling compound 12 is formed as a thixotropic fluid, a viscosity of the cavity-filling compound 12 is reduced by the vibration 38. The cavity-filling compound 12 can hereby be injected more efficiently into the cavity 30 and distributed there.

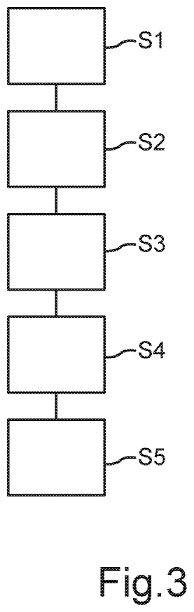

FIG. 3 then schematically shows method steps of an embodiment of the method according to the invention. According to the embodiment described herein, in one method step S1, a battery 40 is provided with at least one battery module 26 and a battery housing 24 enclosing the battery module 26. In method step S2, an injection nozzle 14 is connected to a predetermined injection site 22 of the battery housing 24. In a further method step S3, a vacuum-generation device 16, particularly a pump, is connected to the sealed battery housing 24. The vacuum-generation device 16 then generates a vacuum in the battery housing 24. In a further step S5, the cavity-filling compound 12 is injected into the battery housing 24, which is being subjected to the vacuum, through the injection nozzle 14. During injection, i.e. during method step S5, the cavity-filling compound 12 is drawn into a cavity 30 between the battery housing 24 and battery module 26 and distributed there by means of the vacuum.

In an especially preferred embodiment, a distribution device 10 is provided with a specific counter-holder device (i.e. with a vacuum-generation device 16, which is equipped with a cover 18 or a sealing cup) and an injection nozzle 14. By means of the vacuum generated as described, the injection nozzle 14 can be suctioned to the battery housing 24 or to a temperature control device of the battery 40 or cooling system of the battery 40 or to a cooling base of the battery 40, and the cavity-filling compound 12, which can be implemented particularly as a thermally conductive medium or a thermally conductive paste, is injected into the cavity 30.

By withdrawing and/or removing the cooling system of the battery 40 or by enlarging a distance between the battery housing 24 and the at least one battery module 26, a suction effect can be generated, on the one hand, and a flow cross-section can be obtained, on the other hand, whereby the cavity-filling compound 12 or the gap filler can penetrate or flow into the cavity 30 and be distributed there.

Thus, the injection of the cavity-filling compound 12 is supported by the vacuum. A counter-pressure counteracting the injection can advantageously be reduced by the vacuum. The processing time required for the injection can advantageously be shortened due to the thusly facilitated injecting of the cavity-filling compound 12.

The examples as a whole show how a device and a method can be provided by the invention for the efficient and material-protecting application of a cavity-filling compound into a cavity described above and for the distribution of the cavity-filling compound in the cavity.

1. A distribution device comprising:
a cavity-filling compound in a cavity between at least one outer side of at least one battery module of a battery and an inner side, facing the at least one outer side of the respective battery module of the battery, of a battery housing at least partially enclosing the respective battery module,
wherein the distribution device has at least one injection nozzle and a vacuum-generation device, wherein the at least one injection nozzle is designed to inject the cavity-filling compound into the cavity, and wherein the vacuum-generation device is designed to generate a vacuum in an interior of the sealed battery housing, said interior further comprising the cavity, and to draw the injected cavity-filling compound into the cavity and to distribute it there by means of the vacuum.

2. The distribution device according to claim 1, wherein the vacuum-generation device has a cover or a sealing cup for sealing the battery housing.

3. The distribution device according to claim 1, wherein the vacuum-generation device is configured to suction the at least one injection nozzle to the battery housing, by the vacuum, at least one predetermined injection site.

4. The distribution device according to claim 1, wherein the injection nozzle has a pressure-retention device which is configured to establish and maintain a counter-pressure counteracting an expansion pressure of the cavity-filling compound.

5. The distribution device according to claim 1, wherein a vibration-generation device for generating a vibration in the injection nozzle and/or in the cavity-filling compound is provided on the injection nozzle.

6. The distribution device according to claim 1, wherein a mechanical vibrator is configured to transfer a vibratory movement, which is acting in at least one spatial direction, to the battery housing during injection.

7. The distribution device according to claim 1, wherein the cavity-filling compound is formed as a thixotropic fluid.

8. A method comprising:
distributing a cavity-filling compound in a cavity between at least one outer side of at least one battery module of a battery and an inner side, facing the at least one outer side of the respective battery module of the battery, of a battery housing at least partially enclosing the respective battery module,
wherein at least one injection nozzle injects the cavity-filling compound into the cavity, and in that a vacuum-generation device generates a vacuum in an interior of the sealed battery housing, said interior further comprising the cavity, and draws the injected cavity-filling compound into the cavity and distributes it there by the vacuum.

9. The method according to claim 8, wherein the at least one battery module and the battery housing are moved relative to one another during injection of the cavity-filling compound.

10. The method according to claim 8, wherein a distance is enlarged between the at least one battery module and the battery housing in order to produce a suction effect during injection, and the cavity-filling compound is drawn into the cavity by the suction effect and distributed there.

11. The distribution device according to claim 2, wherein the vacuum-generation device is configured to suction the at least one injection nozzle to the battery housing, by the vacuum, at least one predetermined injection site.

12. The distribution device according to claim 2, wherein the injection nozzle has a pressure-retention device which is configured to establish and maintain a counter-pressure counteracting an expansion pressure of the cavity-filling compound.

13. The distribution device according to claim 3, wherein the injection nozzle has a pressure-retention device which is configured to establish and maintain a counter-pressure counteracting an expansion pressure of the cavity-filling compound.

14. The distribution device according to claim 2, wherein a vibration-generation device for generating a vibration in the injection nozzle and/or in the cavity-filling compound is provided on the injection nozzle.

15. The distribution device according to claim 3, wherein a vibration-generation device for generating a vibration in the injection nozzle and/or in the cavity-filling compound is provided on the injection nozzle.

16. The distribution device according to claim 4, wherein a vibration-generation device for generating a vibration in the injection nozzle and/or in the cavity-filling compound is provided on the injection nozzle.

17. The distribution device according to claim 2, wherein a mechanical vibrator is configured to transfer a vibratory movement, which is acting in at least one spatial direction, to the battery housing during injection.

18. The distribution device according to claim 3, wherein a mechanical vibrator is configured to transfer a vibratory movement, which is acting in at least one spatial direction, to the battery housing during injection.

19. The distribution device according to claim 4, wherein a mechanical vibrator is configured to transfer a vibratory movement, which is acting in at least one spatial direction, to the battery housing during injection.

20. The distribution device according to claim 5, wherein a mechanical vibrator is configured to transfer a vibratory movement, which is acting in at least one spatial direction, to the battery housing during injection.
